(19) United States
(12) Patent Application Publication
(10) Pub. No.: US 2019/0188631 A1
(43) Pub. Date: Jun. 20, 2019

(54) SYSTEMS AND METHODS FOR MULTI-SENSOR TAG SALE OPTIMIZATION

(71) Applicants: Mohammad Mohiuddin, Boynton Beach, FL (US); Hubert A. Patterson, Boca Raton, FL (US); Melwyn F. Sequeira, Plantation, FL (US)

(72) Inventors: Mohammad Mohiuddin, Boynton Beach, FL (US); Hubert A. Patterson, Boca Raton, FL (US); Melwyn F. Sequeira, Plantation, FL (US)

(73) Assignee: Tyco Fire & Security GmbH, Neuhausen Am Rheinfall (CH)

(21) Appl. No.: 15/849,231

(22) Filed: Dec. 20, 2017

(51) Int. Cl. G06Q 10/08; G06Q 20/20; G06K 7/10; G06K 17/00

(52) U.S. Cl. CPC G06Q 10/087; G06Q 20/203; G06K 2017/0051; G06K 17/0022; G06K 7/10366

(57) ABSTRACT

Systems and methods for multi-sensor tag sale optimization. The methods comprise: analyzing sensor data generated by sensors internal to a tag, coupled to an item of an item set that is being handled by a first individual, to determine if the item was carried to a checkout lane of a retail store; and determining whether a sale conversion for the item occurred. If a sale conversion for the item occurred, performing the following operations: analyzing historical sale transaction information to determine a total number of sales of items in the item set over a first given period of time; comparing the total number of sales to a first threshold value; and causing content displayed on the tag's electronic visual display to be dynamically changed so as to include a sale price for the item, when the total number of sales is less than or equal to the first threshold value.

### FIELD

This document relates generally to intelligence systems (e.g., for retail applications). More particularly, this document relates to implementing systems and methods for multi-sensor tag sale optimization.

### BACKGROUND

More and more retailers are depending on big data to make decisions about their inventory. Retailers desire solutions for gathering data from customers and pricing merchandise accordingly. Retailers also want to learn which items are selling fastest and how customers interact with those items in real time. Currently there is no resource efficient and/or relatively inexpensive way to understand how customers view and interact with an item before making the decision to buy or not to buy.

### SUMMARY

The present disclosure concerns implementing systems and methods for multi-sensor tag sale optimization. The methods comprising: analyzing, by a processing circuit, sensor data generated by sensors internal to a tag, coupled to an item of an item set that is being handled by a first individual, to determine if the item was carried to a checkout lane of a retail store; and determining, by the processing circuit, whether a sale conversion for the item occurred. If a sale conversion for the item occurred, the processing circuit performs the following operations: analyzing historical sale transaction information to determine a total number of sales of items in the item set over a first given period of time; comparing the total number of sales to a first threshold value; and causing content displayed on the tag's electronic visual display to be dynamically changed so as to include a sale price for the item, when the total number of sales is less than or equal to the first threshold value. The tag may also be caused to output an auditory alert informing individuals that the item has been placed on sale. The processing circuit is at least partially implemented in at least one of the tag and a computing device remotely located from the tag.

In some scenarios, the sensor data is also analyzed to determine if the item was handled at a first location in a facility and left at the first location. If so, the following operations are performed: determining a total number of times the item was handled and placed back at the first location over a second given period of time; and comparing the total number of times the item was handled and placed back at the first location over a second given period of time to a second threshold value. When the total number of times the item was handled and placed back at the first location over a second given period of time exceeds the second threshold value, a second individual is notified that the second threshold value has been exceeded so that the second individual can make a determination as to whether the display location of the item should be changed. Alternatively or additionally, the processing circuit determines a proposed new display location for the item in the facility based on pre-defined criteria, and notifies the second individual of the proposed new display location. The pre-defined criteria includes, but is not limited to, (a) item type categories assigned to different sections of the facility, (b) the item's type categorization, (c) the item's priority level relative to that of other items, and/or (d) historical data indicating which physical locations in a section of the facility have higher sale rates.

In those or other scenarios, the sensor data is analyzed to determine if the item was picked up from the first location and dropped off at a second different location. The second individual is notified that that the item has been misplaced when a determination is made that the item was picked up from the first location and dropped off at a second different location. The following operations may optionally also be performed: determining if the item is a cold storage item; determining if the second location is a cold storage location; determining an amount of time the item has been removed from cold storage when a determination is made that the item is a cold storage item and the second location is not a cold storage location; comparing the amount of time to a third threshold value; and issuing a warning message to the second individual that (a) the item has passed an expiry period when the amount of time is greater than the third threshold value or (b) there is a certain amount of time until the item reaches the expiry period when the amount of time is less than the third threshold value. The tag may be further be caused to output an alert alerting onlookers that the item passed the expiry period or is about to pass the expiry period.

In those or other scenarios, the sensor data is analyzed to determine if the item left the facility without a sale conversion. If so, the second individual is notified of a possible theft of the item.

### DESCRIPTION OF THE DRAWINGS

The present solution will be described with reference to the following drawing figures, in which like numerals represent like items throughout the figures.

FIG. 1 is an illustration of an illustrative system.

FIG. 2 is an illustration of an exemplary Electronic Smart Tag (“EST”).

FIG. 3 is a block diagram of an illustrative architecture for the EST of FIG. 2.

FIG. 4 is a block diagram of an illustrative architecture for a power management circuit of the EST of FIGS. 2-3.

FIG. 5 is a block diagram of an illustrative architecture for a computing device.

FIGS. 6A-6E (collectively referred to as “FIG. 6”) provide a flow diagram of an illustrative method for multi-sensor tag sale optimization.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout the specification may, but do not necessarily, refer to the same embodiment.

Furthermore, the described features, advantages and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

The present solution generally concerns implementing systems and methods for multi-sensor tag sale optimization. When an individual (e.g., a customer) handles an item to which a tag is coupled, sensor data is generated by the tag. The sensor data is analyzed to determine whether the item was carried to a checkout lane where a sale conversion occurred, whether the item was picked up from one location in a facility and dropped off at another location in the facility thereby indicating that the individual changed his(her) mind to purchase the item, whether the item was left at the same location thereby indicating that no sale of the item occurred, or whether the item left the building without registering a sale thereby indicating that the item was stolen. This analysis can be performed by the tag or a remote computing device that is part of an enterprise system.

The results of this analysis can be used to assist managers in deciding whether a particular item is displayed at an appropriate location within a facility. The results of the analysis can also be used to determine if the total number of sales of an item over a given period of time falls below a threshold value. In this case, the item can be automatically placed on sale. Operations of the tag can be controlled to output an indication that the item is on sale. For example, the tag is caused to emit a colored flashing light for capturing the attention of individuals in proximity to the item. The present solution is not limited to the particulars of this example.

Additionally, a combination of the tag's temperature sensor and timer are used to track how long an item has been removed from cold storage. From this tracked time, the change in the item's temperature is computed as a delta value. The delta value is used to detect when the item is nearing its expiry period such that the item can be discarded on time without jeopardizing public health.

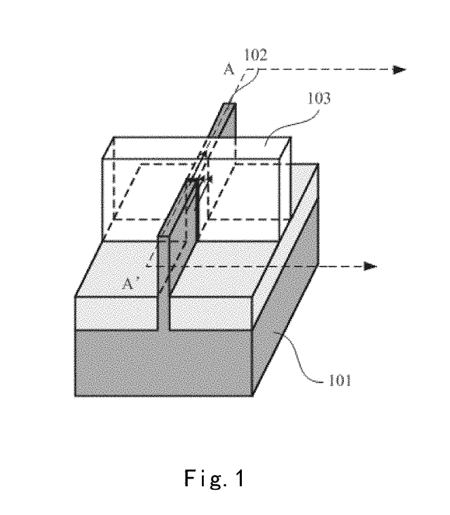

Referring now to FIG. 1, there is provided an illustration of an illustrative system 100. System 100 is entirely or at least partially disposed within a facility 102. The facility 102 can include, but is not limited to, a manufacturer's facility, a distribution center facility, a retail store facility or other facility within a supply chain.

As shown in FIG. 1, at least one item 118 resides within the facility 102. The item 118 has a smart tag 120 coupled thereto. This coupling is achieved via an adhesive (e.g., glue, tape or sticker), a mechanical coupler (e.g., straps, clamps, snaps, etc.), a weld, chemical bond or other means. The smart tag 120 is generally configured to provide a visual and/or auditory output of item level information and/or discount information. The item level information includes, but is not limited to, an item description, item nutritional information, a promotional message, an item regular price, an item sale price, a currency symbol, and/or a source of the item. The discount information includes, but is not limited to, a reduced price for an item.

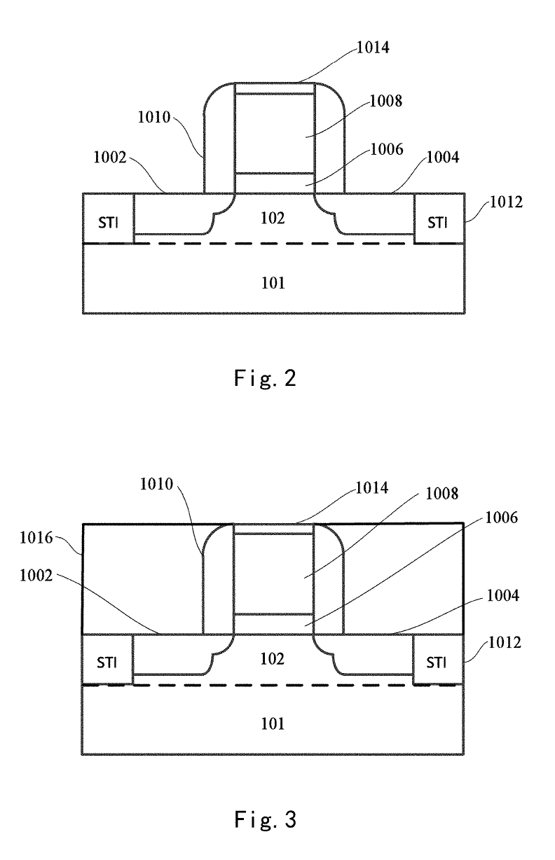

The smart tag 120 will be described in detail below in relation to FIGS. 2-4. The item level information and/or discount information can be output in a format selected from a plurality of formats based on a geographic location of the item, a date, and/or an item pricing status (e.g., whether the item is on sale). In a display context, the format is defined by a font parameter, a color parameter, a brightness parameter, and/or a display blinking parameter. In an auditory context, the format is defined by a volume parameter, a voice tone parameter, and/or a male/female voice selection parameter.

The item 118 is disposed on display equipment 122. The display equipment includes, but is not limited to, shelves 106₁-106₃, display cabinets, and/or exhibit cases. In the shelf scenario, each shelf 106₁-106₃ may have an Electronic Smart Label (“ESL”) affixed thereto. ESLs are well known in the art, and therefore will not be described herein. Still, it should be understood that the ESLs display information relating to the items stored on the respective shelves. In some scenarios, the ESLs are connected to a corporate network via long-range radio technology. In this case, the ESLs may communicate with the smart tags via a short-range or long-range radio and provide informational updates thereto.

The smart tag 120 and ESLs 104₁-104₃ comprise wireless communication components that enable the communication of item level information 116 and/or discount information 132 thereto and/or therefrom. The wireless communication components can implement one or more different types of communication technology. The communication technologies can include, but are not limited to, Radio Frequency (“RF”) communication technology, Bluetooth technology, WiFi technology, Sub GHz technology, beacon technology, and/or LiFi technology. Each of the listed types of communication technology are well known in the art, and therefore will not be described herein.

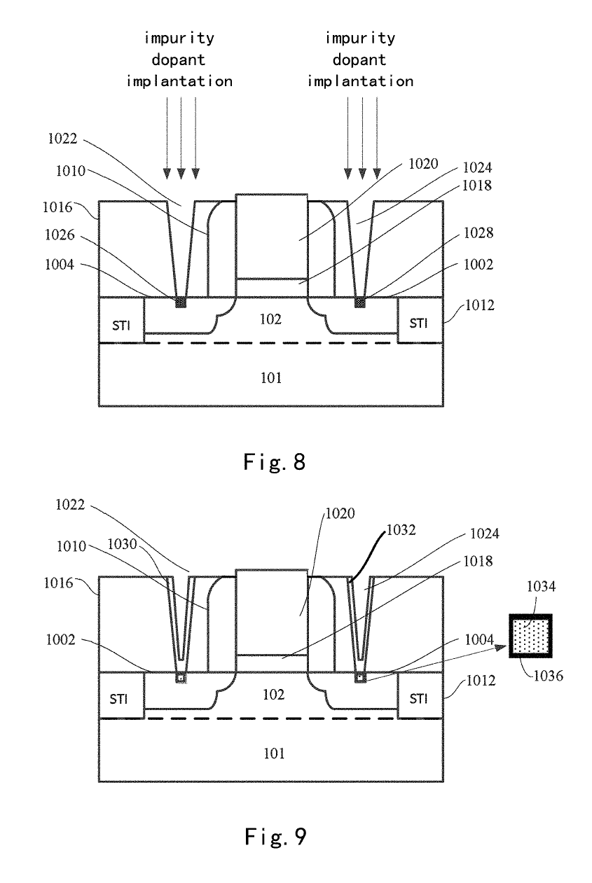

The item level information 116 and/or discount information 132 is provided to the smart tag, ESLs and/or mobile device 126 from a computing device 112 via a network 110. The computing device 112 can be local to the facility 102 as shown in FIG. 1 or remote from the facility 102. The computing device 112 will be described in detail below in relation to FIG. 5. However, at this time, it should be understood that the computing device 112 is configured to: write data to and read data from a database 114, smart tag 120, ESLs 104₁-104₃, and/or mobile device 126; and/or perform language and currency conversion operations using item level information and/or accessory information obtained from the database 114, smart tag 120, ESLs 104₁-104₃ and/or mobile device 126. The data can include, but is not limited to, item level information 116 and/or discount information 132.

Accordingly, the computing device 112 facilitates updates to the item level information and/or discount information output from the smart tags, ESLs and/or mobile devices. Such information updating can be performed periodically, in response to instructions received from an associate (e.g., a retail store employee), in response to a detected change in the item level and/or discount information, in response to a detection that an individual is in proximity to the smart tag or ESL, in response to any motion or movement of the smart tag, and/or in response to a detection that the sale of the item has fallen below a threshold value. For example, if a certain product is placed on sale, then the sale price for that product is transmitted to access point 128, which in turn transmits the sale price to each smart tag/ESL associated with that product. The sale price is then output from the smart tags/ESLs. The present solution is not limited to the particulars of this example.

In some scenarios, information stored in datastore 114 is downloaded to the mobile device. The information can be rewritten in smart tag 120 directly from the mobile device (either by using mobile device 126 or a different mobile device). If the mobile device is not capable of direct interaction with the smart tag 120, then an add-on (such as RFID reader) can be used to accomplish the writing.

The network 110 interconnects the computing device 112 with at least one access point 128. Network 110 can be a wired or wireless network facilitating communication between computing device 112 and the access point 128. The access point 128 receives the item level information 116, accessory information 132, related product information 136, discount information 138 and/or customer related information 140 from the computing device 112, optionally translates this information, and sends it to the smart tag 120, ESLs 104₁-104₃ and/or mobile device 126 via wireless communication links 124.

Although a single computing device 112 is shown in FIG. 1, the present solution is not limited in this regard. It is contemplated that more than one computing device can be implemented. Also, the present solution is not limited to the illustrative system architecture described in relation to FIG. 1. For example in other scenarios, the present solution is used in a system such as that disclosed in U.S. Patent Publication No. 2012/0326849 to Relihan et al. (incorporated herein by reference).

During operations of system 100, an individual (e.g., a customer) handles the item 118 to which the smart tag 120 is coupled. While being handled, the smart tag 120 generates sensor data. In this regard, the smart tag 120 comprises internal sensors, such as an Inertial Measurement Unit (“IMU”) and/or a light sensor.

The sensor data is analyzed by the smart tag 120 or the remote computing device 112 for various reasons. For example, the sensor data is analyzed to determine whether: the item 118 was carried to a checkout lane such that a sale conversion occurred; the item 118 was picked up from one location in the facility 102 and dropped off at another location in the facility 102 thereby indicating that the individual changed his(her) mind to purchase the item; the item 118 was left at the same location thereby indicating that no sale of the item occurred; or the item 118 left the facility without registering a sale thereby indicating that the item was stolen.

The result of this analysis is used to assist enterprise employees (e.g., managers) in deciding whether the item 118 is displayed at an appropriate location within the facility 102. If so, then no further action is taken. If so, then actions can be taken to relocate the item within the facility to a location expected to result in increased sales of the item.

The results of the analysis can also be used to determine when the number of sales of the item 118 falls below a threshold value (e.g., 20) over a given period of time (e.g., hours, days, week or months). In this case, the item 118 can be automatically placed on sale. Operations of the smart tag 120 can be controlled to output an indication that the item is on sale. For example, the smart tag 120 is caused to emit a colored flashing light for capturing the attention of individuals in proximity to the item 118. The present solution is not limited to the particulars of this example.

Additionally or alternatively, a combination of the smart tag's local temperature sensor and timer are used to track how long the item 118 has been removed from cold storage. From this tracked time, the change in the item's temperature is computed as a delta value. The delta value is used to detect when the item 118 is nearing its expiry period such that the item can be discarded on time without jeopardizing public health.

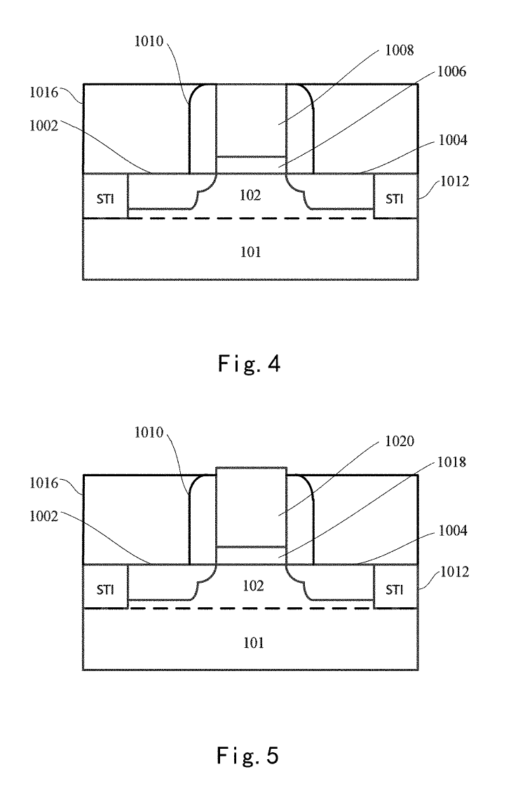

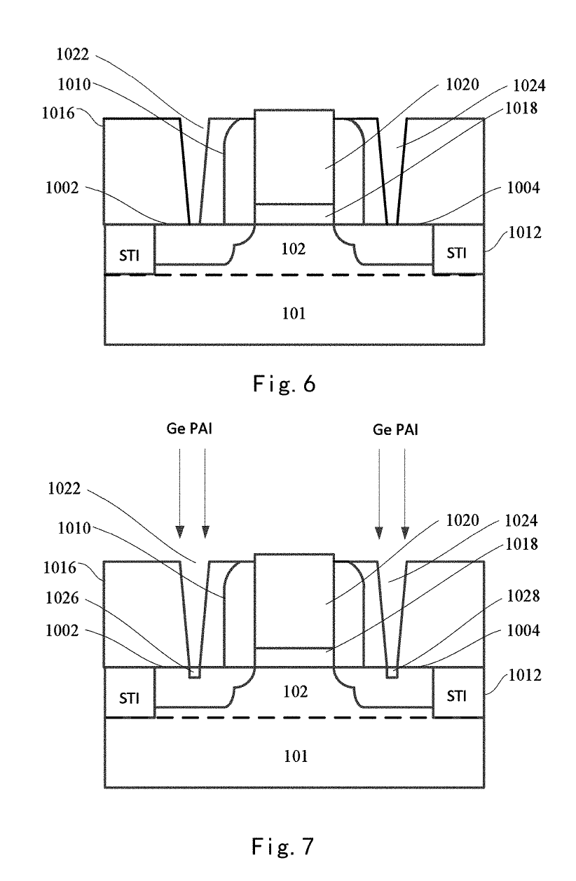

Referring now to FIG. 2, there is an illustration of an exemplary EST 200 displaying item level information. An exemplary architecture for the EST 200 is provided in FIGS. 3-4. Smart tag 120 and/or ESLs 104₁-104₃ of FIG. 1 is/are the same as or substantially similar to EST 200. As such, the discussion of EST 200 is sufficient for understanding the smart tag 120 and/or ESLs 104₁-104₃ of FIG. 1.

The EST 200 can include more or less components than that shown in FIG. 3. However, the components shown are sufficient to disclose an illustrative embodiment implementing the present solution. Some or all of the components of the EST 200 can be implemented in hardware, software and/or a combination of hardware and software. The hardware includes, but is not limited to, one or more electronic circuits. The electronic circuit(s) may comprise passive components (e.g., capacitors and resistors) and active components (e.g., processors) arranged and/or programmed to implement the methods disclosed herein.

The hardware architecture of FIG. 3 represents a representative EST 200 configured to facilitate improved inventory management, merchandise sales, and/or customer experience. In this regard, the EST 200 is configured for allowing data to be exchanged with an external device (e.g., computing device 112 of FIG. 1) via wireless communication technology. The wireless communication technology can include, but is not limited to, a Radio Frequency Identification (“RFID”) technology, an NFC technology, and/or a Short Range Communication (“SRC”) technology. For example, one or more of the following wireless communication technologies (is)are employed: Radio Frequency (“RF”) communication technology; Bluetooth technology; WiFi technology; Sub-GHz technology; beacon technology; and/or LiFi technology. Each of the listed wireless communication technologies is well known in the art, and therefore will not be described in detail herein. Any known or to be known wireless communication technology or other wireless communication technology can be used herein without limitation.

The components 306-318 shown in FIG. 3 may be collectively referred to herein as a communication enabled device 304, and include a memory 308 and a clock/timer 318. Memory 308 may be a volatile memory and/or a non-volatile memory. For example, the memory 308 can include, but is not limited to, Random Access Memory (“RAM”), Dynamic RAM (“DRAM”), Static RAM (“SRAM”), Read Only Memory (“ROM”) and flash memory. The memory 308 may also comprise unsecure memory and/or secure memory.

In some scenarios, the communication enabled device 304 comprises a Software Defined Radio (“SDR”). SDRs are well known in the art, and therefore will not be described in detail herein. However, it should be noted that the SDR can be programmatically assigned any communication protocol that is chosen by a user (e.g., RFID, WiFi, LiFi, Bluetooth, BLE, Nest, ZWave, Zigbee, etc.). The communication protocols are part of the device's firmware and reside in memory 308. Notably, the communication protocols can be downloaded to the device at any given time. The initial/default role (being an RFID, WiFi, LiFi, etc. tag) can be assigned at the deployment thereof. If the user desires to use another protocol at a later time, the user can remotely change the communication protocol of the deployed EST 200. The update of the firmware, in case of issues, can also be performed remotely.

As shown in FIG. 3, the communication enabled device 304 comprises at least one antenna 302, 312 for allowing data to be exchanged with the external device via a wireless communication technology (e.g., an RFID technology, an NFC technology and/or a SRC technology). The antenna 302, 312 is configured to receive signals from the external device and/or transmit signals generated by the communication enabled device 304. In some scenarios, the antenna 302, 312 comprises a near-field or far-field antenna. The antennas includes, but are not limited to, a chip antenna or a loop antenna.

The communication enabled device 304 also comprises a transceiver 306. Transceivers are well known in the art, and therefore will not be described herein. However, it should be understood that the transceiver 306 generates and transmits signals (e.g., RF carrier signals) to external devices, as well as receives signals (e.g., RF signals) transmitted from external devices. In this way, the communication enabled device 304 facilitates the registration, identification, location and/or tracking of an item (e.g., item 118 of FIG. 1) to which the EST 200 is coupled. The communication enabled device 304 also facilitates the automatic and dynamic modification of item level information and/or discount information that is being or is to be output from the EST 200 in response to certain trigger events. The trigger events can include, but are not limited to, the EST's arrival at a particular facility (e.g., facility 102 of FIG. 1), the EST's arrival in a particular country or geographic region, a date occurrence, a time occurrence, a price change, the reception of user instructions, the detection of an individual in proximity to an item (e.g., item 118 of FIG. 1) to which the EST is coupled, the detection motion/movement of an item (e.g., item 118 of FIG. 1) to which the EST is coupled, and/or the detection that the number of sales of the item have fallen below a threshold value over a given period of time.

Item level information 314 and/or discount information 324, and/or other information 326 associated with the identification, location and/or motion/movement of the EST 200 can be stored in memory 308 of the communication enabled device 304 and/or communicated to other external devices (e.g., computing device 112 of FIG. 1 and/or mobile device 126 of FIG. 1) via transceiver 306 and/or interface 340 (e.g., an Internet Protocol or cellular network interface). For example, the communication enabled device 304 can communicate information specifying a timestamp, a unique identifier, item description, item price, a currency symbol, a price discount, location information, and/or motion/movement information to an external computing device. The external computing device (e.g., server) can then store the information in a datastore (e.g., datastore 114 of FIG. 1) and/or use the information during language and/or currency conversion operations and/or during tag display change operations.

The communication enabled device 304 also comprises a controller (or processor circuit) 310 and input/output devices 316. The controller 310 can also execute instructions 322 implementing methods for facilitating item inventorying, merchandise sales and/or customer satisfaction. In this regard, the controller 310 includes a processor (or logic circuitry that responds to instructions) and the memory 308 includes a computer-readable storage medium on which is stored one or more sets of instructions 322 (e.g., software code) configured to implement one or more of the methodologies, procedures, or functions described herein. The instructions 322 can also reside, completely or at least partially, within the controller 310 during execution thereof by the EST 200. The memory 308 and the controller 310 also can constitute machine-readable media. The term “machine-readable media”, as used here, refers to a single medium or multiple media (e.g., a centralized or distributed database, and/or associated caches and servers) that store the one or more sets of instructions 322. The term “machine-readable media”, as used here, also refers to any medium that is capable of storing, encoding or carrying a set of instructions 322 for execution by the EST 200 and that cause the EST 200 to perform any one or more of the methodologies of the present disclosure.

The input/output devices can include, but are not limited to, a display (e.g., an E Ink display, an LCD display and/or an active matrix display), a speaker, a keypad and/or light emitting diodes. The display is used to present item level information and/or discount information in a textual format and/or graphical format. Similarly, the speaker may be used to output item level information and/or discount information in an auditory format. The speaker and/or light emitting diodes may be used to output alerts for drawing a person's attention to the EST 200 and/or for notifying the person of a particular pricing status (e.g., on sale status) of the item to which the EST is coupled.

The clock/timer 318 is configured to determine a date, a time, and/or an expiration of a pre-defined period of time. Technique for determining these listed items are well known in the art, and therefore will not be described herein. Any known or to be known technique for determining these listed items can be used herein without limitation.

The EST 200 also comprises an optional location module 330. The location module 330 is generally configured to determine the geographic location of the EST at any given time. For example, in some scenarios, the location module 330 employs Global Positioning System (“GPS”) technology and/or Internet based local time acquisition technology. The present solution is not limited to the particulars of this example. Any known or to be known technique for determining a geographic location can be used herein without limitation.

The optional coupler 342 is provided to securely or removably couple the EST 200 to an item (e.g., item 118 of FIG. 1). The coupler 342 includes, but is not limited to, a mechanical coupling means (e.g., a strap, clip, clamp, snap) and/or adhesive (e.g., glue or sticker). The coupler 342 is optional since the coupling can be achieved via a weld and/or chemical bond.

The EST 200 can also include an optional rechargeable battery 336, an optional Electronic Article Surveillance (“EAS”) component 344, and/or an operational passive/active/semi-passive RFID component 346. Each of the listed optional components 336, 344, 346 is well known in the art, and therefore will not be described herein. Any known or to be known battery, EAS component and/or RFID component can be used herein without limitation.

As shown in FIG. 2, the EST 200 further comprises an energy harvesting circuit 332 and a power management circuit 334 for ensuring continuous operation of the EST 200 without the need to change a battery. In some scenarios, the energy harvesting circuit 302 is configured to harvest energy from one or more sources (e.g., heat, light, vibration, magnetic field, and/or RF energy) and to generate a relatively low amount of output power from the harvested energy. By employing multiple sources for harvesting, the device can continue to charge despite the depletion of a source of energy.

The energy harvesting circuit 332 can operate in two (2) ways. First, the energy harvesting circuit 332 can harvest energy from an available source while online (i.e., when the EST 200 is attached to merchandise). Second, the energy harvesting circuit 332 can harvest energy while offline (i.e., when the EST 200 is detached from merchandise) via a charging station/bin. This ensures that the EST 200 is fully charged when the EST is ready to be deployed or go online.

The energy harvesting circuit 332 can also be supplemented with bigger harvesters and/or a mains power source. In this case, the energy harvesting circuit 332 can be placed closer to its primary source (e.g., a solar panel on top of a shelf) and power from there can be distributed over two (2) wires. The design allows multiple labels to be connected to a single harvester circuit. The harvester circuit can be replaces with the mains power source.

The EST 200 may also include optional sensors 350 employing environmental and proximity sensing technology. The sensors 350 can include, but are not limited to, a light sensor, a fluid/liquid/humidity sensor, an IR detector, a camera, a proximity sensor, an IMU, an accelerometer, a gyroscope, and/or an RF detection unit. The input/output devices 316 (e.g., the display) can be turned off when a person is not located in proximity thereto. This capability is useful when the input/output devices 316 (e.g., the display) is not considered low power.

The power management circuit 334 is generally configured to control the supply of power to components of the EST 200. In the event all of the storage and harvesting resources deplete to a point where the EST 200 is about to enter a shutdown/brownout state, the power management circuit 334 can cause an alert to be sent from the EST 200 to a remote device (e.g., computing device 112 of FIG. 1). In response to the alert, the remote device can inform an associate (e.g., a store employee) so that (s)he can investigate why the EST 200 is not recharging and/or holding charge.

The power management circuit 334 is also capable of redirecting an energy source to the EST's 200 electronics based on the energy source's status. For example, if harvested energy is sufficient to run the EST's 200 function, the power management circuit 334 confirms that all of the EST's 200 storage sources are fully charged such that the EST's 200 electronic components can be run directly from the harvested energy. This ensures that the EST 200 always has stored energy in case harvesting source(s) disappear or lesser energy is harvested for reasons such as drop in RF, light or vibration power levels. If a sudden drop in any of the energy sources is detected, the power management circuit 334 can cause an alert condition to be sent from the EST 200 to the remote device (e.g., computing device 112 of FIG. 1). At this point, an investigation may be required as to what caused this alarm. Accordingly, the remote device can inform the associate (e.g., a store employee) so that (s)he can investigate the issue. It may be that other merchandise are obscuring the harvesting source or the item is being stolen.

Referring now to FIG. 4, there is provided a block diagram of an exemplary architecture 400 for the power management circuit 334 of the EST 200. The power management circuit 334 is not limited to the particular architecture shown in FIG. 4. In this regard, it should be understood that that power management circuit 334 can include more or less components than that shown in FIG. 4.

The power management circuit 334 is configured to provide a way in which the EST 200 is: deployable as a plug-n-play energy harvested wireless sensor that is ready to function as soon as it is turned on; and a self-sustaining sensor system wherein its power source would virtually never need to be replaced. In this regard, the power management circuit 334 is electrically connected to the energy harvesting circuit 332 and the optional rechargeable battery 336. The power management circuit 334 comprises switches 404, 406, an Energy Harvester Power Manager (“EHPM”) 408, a Super Capacitor (“SC”) storage element 414, a smart charger 412 for the SC storage element, a microcontroller 416, and a DC-DC voltage converter 420 electrically connected to a load(s) 422. The microcontroller 416 can be the same as or separate/distinct from the controller 310 of FIG. 3. The load 422 can include, but is not limited to, components 304, 330, 340, 350, 344 and/or 346 of FIG. 3.

In some scenarios, the energy harvesting circuit 332 comprises a solar cell circuit. The present solution is not limited in this regard. Other types of energy harvesting circuits can be used herein that generate a relatively low amount of output power.

At initial power up of the EST 200, the SC storage element 414 is assumed to be in a completely discharged state. Thus, the initial charge of the SC storage element 414 is at a level of approximately or substantially equal to zero volts. However, the rechargeable battery 336 is in a quasi-discharged state in which its initial charge is at a level greater than zero volts (e.g., 3 volts). As such, the rechargeable battery 336 has a sufficient amount of initial stored energy to nearly instantaneously enable operations of the control electronics of the EST 200. In this regard, an output voltage 436 is supplied from the rechargeable battery 336 to the EHPM 408 via switch 404, whereby operations of boost converters 424 contained in the EHPM 408 are started immediately after turning on the EST 200. The output voltage 436 is also supplied from the rechargeable battery 336 to the microcontroller 416 via the EHPM 408.

The available power from rechargeable battery is also used at this time to charge the SC storage element 414. In this regard, the output voltage 436 of the rechargeable battery 336 is supplied to the SC storage element 414 via switch 406 and smart charger 412, whereby charging of the SC storage element is expedited. An output voltage 438 of the SC storage element is supplied to the load(s) 422 via the voltage converter 420. The EST 200 is considered fully operational when the output voltage 438 reaches a level (e.g., 3.8 V) that is sufficient to cause the load(s) to perform the intended operations thereof.

Throughout operation of the EST 200, the microcontroller 416 monitors the output voltage 434 of the solar cell circuit 402, as well as the output voltage 436 of the rechargeable battery and the output voltage 438 of the SC storage element 414. Once the output voltage 438 of the SC storage element 414 reaches a desired voltage (e.g., 3.8 V) after system activation (or powering on), the microcontroller 416 enables a timer to time the charging of the SC storage element 414. After a pre-determined time period (e.g., 6 hours), an assumption is made that the SC storage element 414 has reached its leakage current equilibrium, and therefore no longer needs to be charged. In effect, the microcontroller 416 may optionally perform operations at this time to terminate the supply of output voltage 436 to the SC storage element 414 via switch 406 and smart charger 412.

When the output voltage 438 of the SC storage element 414 falls below a threshold value (e.g., 3.3 V), the microcontroller 416 communicates a switch control signal 432 to switch 406 so as cause the output voltage 436 of the rechargeable battery 410 to once again be supplied to the SC storage element 414 via the smart charger 412. Output voltage 436 is supplied to the SC storage element 414 until the output voltage 438 thereof exceeds an upper threshold value. In effect, the SC storage element 414 is recharged whereby the energy expended while driving load(s) 422 is(are) restored.

When the solar cell circuit 402 is active, the output voltage 434 of the solar cell circuit 402 is supplied to the rechargeable battery 336 via EHPM 408. In effect, the rechargeable battery 336 is recharged by the solar cell circuit 402, whereby the energy expended in charging and re-charging the SC storage element 414 is restored while the EST 200 is maintained in its fully operational state.

The above described process of using the rechargeable battery 336 to charge the SC storage element 414 is repeated as needed. Thus, the above described EST 200 performs self-monitoring and charges its respective re-chargeable elements throughout its entire operation.

Referring now to FIG. 5, there is provided a detailed block diagram of an exemplary architecture for a computing device 500. Computing device 112 of FIG. 1 and/or mobile device 126 of FIG. 1 is/are the same as or similar to computing device 500. As such, the following discussion of computing device 500 is sufficient for understanding computing device 112 and/or mobile device 126.

Computing device 500 may include more or less components than those shown in FIG. 5. However, the components shown are sufficient to disclose an illustrative embodiment implementing the present solution. The hardware architecture of FIG. 5 represents one embodiment of a representative Computing device configured to facilitate improved inventory pricing management and customer shopping experience. As such, the computing device 500 of FIG. 5 implements at least a portion of a method for automatically and dynamically modifying item level information, accessory information, related product information, and/or discount information output from smart tags, ESLs and/or mobile devices in accordance with the present solution.

Some or all the components of the computing device 500 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

As shown in FIG. 5, the computing device 500 comprises a user interface 502, a Central Processing Unit (“CPU”) 506, a system bus 510, a memory 512 connected to and accessible by other portions of computing device 500 through system bus 510, and hardware entities 514 connected to system bus 510. The user interface can include input devices (e.g., a keypad 550) and output devices (e.g., speaker 552, a display 554, and/or light emitting diodes 556), which facilitate user-software interactions for controlling operations of the computing device 500.

At least some of the hardware entities 514 perform actions involving access to and use of memory 512, which can be a RAM, a disk driver and/or a Compact Disc Read Only Memory (“CD-ROM”). Hardware entities 514 can include a disk drive unit 516 comprising a computer-readable storage medium 518 on which is stored one or more sets of instructions 320 (e.g., software code) configured to implement one or more of the methodologies, procedures, or functions described herein. The instructions 520 can also reside, completely or at least partially, within the memory 512 and/or within the CPU (or processing circuit) 506 during execution thereof by the computing device 500. The memory 512 and the CPU 506 also can constitute machine-readable media. The term “machine-readable media”, as used here, refers to a single medium or multiple media (e.g., a centralized or distributed database, and/or associated caches and servers) that store the one or more sets of instructions 520. The term “machine-readable media”, as used here, also refers to any medium that is capable of storing, encoding or carrying a set of instructions 320 for execution by the computing device 500 and that cause the computing device 500 to perform any one or more of the methodologies of the present disclosure.

In some scenarios, the hardware entities 514 include an electronic circuit (e.g., a processor) programmed for facilitating item inventorying, merchandise sales, and/or customer satisfaction with a shopping experience. In this regard, it should be understood that the electronic circuit can access and run an inventorying application 524 and a tag display application 526 installed on the computing device 500. The software applications 524-526 are collectively generally operative to: obtain item level information and/or other information from smart tags and/or ESLs; program item level information, and/or discount information onto smart tags and/or ESLs; convert the language, pricing and/or currency symbol of item level information and/or discount information; facilitate registration of smart tags and/or ESLs with enterprise systems; and/or determine when tag display update actions need to be taken based on smart tag information. Other functions of the software applications 524-526 will become apparent as the discussion progresses.

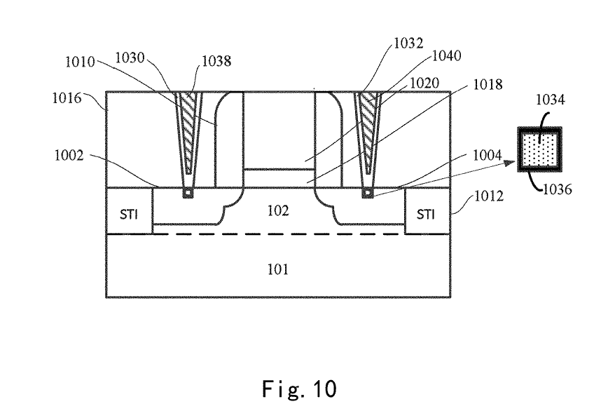

Referring now to FIG. 6, there is provided a flow diagram of an illustrative method 600 for multi-sensor tag sale optimization. Method 600 comprises operations performed in blocks 602-698. The present solution is not limited to the particular order in which the operations of blocks 602-698 are performed in FIG. 6. The location of one or more of the blocks of FIG. 6 can be changed in accordance with a particular application.

As shown in FIG. 6, method 600 begins with 602 and continues with 604 where a tag (e.g., smart tag 120 of FIG. 1) performs operations to detect when an item (e.g., item 118 of FIG. 1) to which it is coupled is being handled by an individual (e.g., a customer). This detection is made using sensors (e.g., sensors 350 of FIG. 3) local to the tag. The sensors can include, but are not limited to, a light sensor, a proximity sensor, and/or an IMU. For example, a detection is made that the item is being handled by an individual when the IMU's sensor data indicates movement of the tag (e.g., other than vibration). Pre-stored movement patterns can be used here to further determine the type of handling and/or particulars of the handling (e.g., a particular portion of the item is being examined). This can be useful in distinguishing tag movement caused by an individual or tag movement caused by an adjacent piece of machinery (e.g., an air conditioner or refrigerator). The present solution is not limited to the particulars of this example.

The tag continues to generate sensor data while the tag is being handled, as shown by 606. In some cases, this sensor data is processed by the tag (e.g., by controller or processing circuit 310 of FIG. 3). However, in other cases, the sensor data is processed by a remote computing device (e.g., computing device 112 of FIG. 1). Accordingly, 608 is provided where the sensor data is optionally communicated from the tag to an enterprise system.

Subsequent to 606 or 608, 610 is performed where the sensor data is analyzed by the tag and/or the enterprise system (e.g., computing device 112 of FIG. 1). The sensor data is analyzed by the tag or enterprise system to determine whether: (a) the item was handled at a first location in a facility (e.g., facility 102 of FIG. 1) and left at the first location; (b) the item was picked up from the first location and dropped off at a second different location; (c) the item was carried to a checkout lane; and/or (d) the item left the facility.

If the item was handled at a first location in a facility and left at the first location [612:YES], then method 600 continues with 622-636 of FIG. 6B. As shown in FIG. 6B, the tag can optionally notify the enterprise system in 622 that the item was handled at a first location and left at the first location. This notification need not be provided if the sensor data is analyzed in 610 by the enterprise system rather than by the tag. In 624, information is stored in a datastore (e.g., datastore 114 of FIG. 1). The information indicates that the item was handled at a first location in a facility and left at the first location. This information may be timestamped, and/or stored as customer-item interaction information (e.g., customer-item interaction information 134 of FIG. 1) in the datastore.

In next 626, historical customer-item interaction information is analyzed by the enterprise system (e.g., computing device 112 of FIG. 1) to determine the total number of times the item was handled and placed back at the first location over a given period of time (e.g., hours, days, weeks, months, or years). If the total number of times is less than or equal to a threshold value [628:NO], then 630 is performed where method 600 returns to 604. The threshold value comprises an integer value (e.g., 10, 50 or 100). If the total number of times is greater than the threshold value [628:YES], then method 600 continues with 631.

631 involves generating or determining a proposed new display location for the item in the facility based on pre-defined criteria. The pre-defined criteria can include, but is not limited to, the item type categories assigned to different sections of the facility, the item's type categorization, the item's priority level relative to that of other items, and/or historical data indicating which physical locations in a section of the facility have higher sale rates. In some scenarios, the new display location for the item is generated or determined automatically by the enterprise system (e.g., computing device 112 of FIG. 1). In other scenarios, the new display location is determined by an individual (e.g., a store manager) an input into the enterprise system (e.g., computing device 112 of FIG. 1). In this case, 631 also involves notifying the individual that the total number of times is greater than the threshold value prior to when the new display location is generated or determined. This notification can be achieved via a push notification to the individual's mobile device (e.g., mobile device 126 of FIG. 1).

If the new display location is automatically determined by the enterprises system, then method 600 continues with optional 632. In 632, a message is optionally generated by the enterprise system (e.g., computing device 112 of FIG. 1). The message includes (a) an indication that the total number of times is greater than the threshold value and (b) the proposed new display location for the item in the facility. The message is communicated from the enterprise system to an individual's (e.g., a store manager's) mobile device (e.g., mobile device 126 of FIG. 1), computing device and/or display device. Techniques for generating and communicating messages are well known in the art, and therefore will not be described herein. Any known or to be known technique for generating and communicating messages can be used herein without limitation. Subsequently, 636 is performed where method 600 ends or other processing is performed (e.g., return to 604).

If the item was picked up from the first location and dropped off at a second different location [614:YES], then method 600 continues with 640-662 of FIG. 6C. As shown in FIG. 6C, 640 involves optionally performing operations by the tag to notify the enterprise system (e.g., computing device 112 of FIG. 1) that the item was picked up from the first location in the facility and dropped off at a second different location in the facility. This notification need not be provided if the sensor data is analyzed in 610 by the enterprise system rather than by the tag.

In 642, a decision is made as whether the item is a cold storage item. This decision can be made using a unique tag identifier and/or a unique item identifier received from the tag. The unique identifier is then used to retrieve item level information from a datastore (e.g., datastore 114 of FIG. 1) indicating whether or not the item is a cold storage item.

If not [642:NO], then 644 is performed where at least one individual (e.g., a store employee) is notified that the item has been misplaced. Method 600 then continues with 662 where it ends or other processing is performed (e.g., return to 604).

If so [642:YES], then method 600 continues with 646 where a decision is made as to whether the second location is a cold storage location. If so [646:YES], 644 is performed. If not [646:NO], method 600 continues with 647. 647 involves notifying at least one individual (e.g., store employee) that the item has been misplaced. This notification can be achieved via a push notification to the individual’ mobile device.

Next in 648, the enterprise system determines the amount of time the item has been removed from cold storage. If the amount of time is greater than a threshold value [650:YES], then a warning message is issued in 652 to at least one individual (e.g., a store employee). The threshold value comprises an integer value. The warning message warns the individual(s) that the item has past it's expiry period. The warning message may be achieved via a push notification to the individual's mobile device. The tag may also optionally be caused to output a visual or auditory alert so that onlookers are alerted to the fact that the item has past it's expiry period, as shown by 654. For example, the tag's displayed content can be dynamically changed to include a warning message, icon or other graphical indicator. Additionally or alternatively, the tag is caused to emit a colored flashing light from an LED. The present solution is not limited in this regard. Subsequently, 662 is performed where method 600 ends or other processing is performed.

If the amount of time is less than or equal to the threshold value [650:NO], then 656 is performed where an amount of time is determined until the item reaches its expiry period. This determination can be made using timestamped sensor data generated by the tag's internal sensors and/or item level information (e.g., item level information 116 of FIG. 1) stored in a data store. The timestamped sensor data can indicate when the item was removed from cold storage, and the item level information can specify the maximum amount of time the item can be removed from cold storage without spoiling.

A warning message is issued in 658 to at least one individual (e.g., a store employee). The warning message informs the individual that there is a certain amount of time until the item reaches its expiry period. The tag can also be optionally caused to output a visual and/or auditory alert so that onlookers are alerted to the fact that the item needs to relocated to cold storage, as shown by 660. For example, the tag's displayed content can be dynamically changed to include a warning message, icon or other graphical indicator. Additionally or alternatively, the tag is caused to emit a colored flashing light from an LED. The light emitted here can be of the same or different color as the light emitted in 654, and in accordance with the same or different flashing pattern as that used in 654. The present solution is not limited in this regard. Subsequently, 662 is performed where method 600 ends or other processing is performed.

If the item was carried to a checkout lane [616:YES], then method 600 continues with 664-690 of FIG. 6D. As shown in FIG. 6D, 664 involves optionally performing operations by the tag to notify the enterprise system that the item was carried to a checkout lane. This notification need not be provided if the sensor data is analyzed in 610 by the enterprise system rather than by the tag.

The enterprise system determines in 666 whether a sale conversion for the item occurred. In some scenarios, this determination is achieved by accessing sale transaction information (e.g., sale transaction information 136 of FIG. 1) stored in a datastore (e.g., datastore 114 of FIG. 1). The sale transaction information includes identifications of items for which a successful purchase was made by a customer. This information can be presented in a searchable table format. In this case, the enterprise system (e.g., computing device 112 of FIG. 1) searches the table for purchase information associated with a unique identifier of the item or the tag to which the item is coupled. The present solution is not limited to the particulars of this scenario.

If a sale conversion did not occur [668:NO], then 670 is performed where method 600 goes to 618 where a determination is made as to whether the item left the facility. In contrast, if a sale conversion did occur [668:YES], then 672 is performed where information is stored in a datastore (e.g., memory 308 of FIG. 3 or datastore 114 of FIG. 1) indicating that a sale conversion of the item occurred. The information can be timestamped.

Thereafter in 674, historical information (e.g., item level information 116, customer-item interaction information 134 and/or sale transaction information 136 of FIG. 1) is retrieved from the datastore (e.g., datastore 114 of FIG. 1) and analyzed to determine the total number of sales of the item over a given period of time (e.g., days, weeks, months, or years). In some scenarios, this determination can be made by incrementing a counter for each successful purchase transaction associated with an item falling in a particular item category (e.g., running shoes) or sub-category (e.g., running shoes of a particular brand and style) that occurred during a given period of time. The final counter value comprises the total number of sales of the item. The present solution is not limited to the particulars of this scenario.

If the total number of sales is greater than a threshold value [676:NO], then 678 is performed where method 600 returns to 604. The threshold value comprises an integer value (e.g., 10, 20 or 100). In contrast, if the total number of sales is less than or equal to the threshold value [676:YES], then method 600 continues with 680.

In 680, the item is placed on sale (e.g., automatically by the enterprise system or in response to a user-software interaction by an individual such as a store manager). Next in 682, a sale price for the item is obtained. The sale price can be obtained from a datastore (e.g., datastore 114 of FIG. 1) or computed using an algorithm (e.g., the original price multiplied by a decimal number selected based on a pre-defined criteria (e.g., time of year, item age, type of item, etc.), where the decimal number has a value less than one).

The sale price is communicated from the enterprise system to the tag in 684. Displayed content of the tag is then dynamically changed to include the sale price, as shown by 686. The tag may also be optionally caused to output a visual and/or auditory alert that the item has been placed on sale, as shown by 688. For example, the tag emits a colored flashing light and/or beeping sound indicating that the item is on sale. Subsequently, method 600 ends or other processing is performed (e.g., return to 604).

If the item left the facility [618:YES], then method 600 continues with 692-698 of FIG. 6E. As shown in FIG. 6E, the tag optionally notifies the enterprise system in 692 that the item left the facility. The enterprise system determines in 693 whether a sale conversion of the item occurred prior to it leaving the facility. In some scenarios, this determination is achieved by accessing sale transaction information (e.g., sale transaction information 136 of FIG. 1) stored in a datastore (e.g., datastore 114 of FIG. 1). The sale transaction information includes identifications of items for which a successful purchase was made by a customer. This information can be presented in a searchable table format. In this case, the enterprise system (e.g., computing device 112 of FIG. 1) searches the table for purchase information associated with a unique identifier of the item or the tag to which the item is coupled. The present solution is not limited to the particulars of this scenario.

If a sale conversion did occur [694:YES], then 695 is performed where method 600 goes to 672. In contrast, if a sale conversion did not occur [694:NO], then 696 is performed where information is stored in a datastore (e.g., datastore 114 of FIG. 1) indicating a possible theft of the item. This information can be timestamped. Additionally, at least one individual (e.g., a store employee or security personnel) is notified of the possible theft, as shown by 697. In response to this notification, individual can take actions to retrieve the item and/or notify an authority (e.g., security guards and/or police). Subsequently, 698 is performed where method 600 ends or other processing is performed (e.g., return to 604).

All of the apparatus, methods, and algorithms disclosed and claimed herein can be made and executed without undue experimentation in light of the present disclosure. While the invention has been described in terms of preferred embodiments, it will be apparent to those having ordinary skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to those having ordinary skill in the art are deemed to be within the spirit, scope and concept of the invention as defined.

The features and functions disclosed above, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

We claim the following:

1. A method for multi-sensor tag sale optimization, comprising:
analyzing, by a processing circuit, sensor data generated by sensors internal to a tag, coupled to an item of an item set that is being handled by a first individual, to determine if the item was carried to a checkout lane of a retail store;
determining, by the processing circuit, whether a sale conversion for the item occurred;
if a sale conversion for the item occurred, performing the following operations by the processing circuit:
analyzing historical sale transaction information to determine a total number of sales of items in the item set over a first given period of time;
comparing the total number of sales to a first threshold value; and
causing content displayed on the tag's electronic visual display to be dynamically changed so as to include a sale price for the item, when the total number of sales is less than or equal to the first threshold value.

2. The method according to claim 1, wherein the processing circuit is at least partially implemented in at least one of the tag and a computing device remotely located from the tag.

3. The method according to claim 1, further comprising causing an auditory alert to be output from the tag for informing individuals that the item has been placed on sale.

4. The method according to claim 1, further comprising analyzing the sensor data to determine if the item was handled at a first location in a facility and left at the first location.

5. The method according to claim 3, further comprising:
determining a total number of times the item was handled and placed back at the first location over a second given period of time;
comparing the total number of times the item was handled and placed back at the first location over a second given period of time to a second threshold value; and
performing at least one of the following operations when the total number of times the item was handled and placed back at the first location over a second given period of time exceeds the second threshold value:
notifying a second individual that the second threshold value has been exceeded so that the second individual can make a determination as to whether the display location of the item should be changed; and
determining a proposed new display location for the item in the facility based on pre-defined criteria, and notifying the second individual of the proposed new display location.

6. The method according to claim 5, wherein the pre-defined criteria comprises at least one of (a) item type categories assigned to different sections of the facility, (b) the item's type categorization, (c) the item's priority level relative to that of other items, and (d) historical data indicating which physical locations in a section of the facility have higher sale rates.

7. The method according to claim 1, further comprising analyzing the sensor data to determine if the item was picked up from the first location and dropped off at a second different location.

8. The method according to claim 7, further comprising notifying a second individual that that the item has been misplaced when a determination is made that the item was picked up from the first location and dropped off at a second different location.

9. The method according to claim 8 further comprising:
determining if the item is a cold storage item;
determining if the second location is a cold storage location;
determining an amount of time the item has been removed from cold storage when a determination is made that the item is a cold storage item and the second location is not a cold storage location;
comparing the amount of time to a third threshold value; and
issuing a warning message to the second individual that (a) the item has passed an expiry period when the amount of time is greater than the third threshold value or (b) there is a certain amount of time until the item reaches the expiry period when the amount of time is less than the third threshold value.

10. The method according to claim 9, further comprising causing an alert to be output from the tag alerting onlookers that the item passed the expiry period or is about to pass the expiry period.

11. The method according to claim 1, further comprising:
analyzing the sensor data to determine if the item left the facility without a sale conversion; and
notifying a second individual of a possible theft of the item if a determination is made that the item left the facility without a sale conversion.

12. A system, comprising:
a processor; and
a non-transitory computer-readable storage medium comprising programming instructions that are configured to cause the processor to implement a method for multi-sensor tag sale optimization, wherein the programming instructions comprise instructions to:
analyze sensor data generated by sensors internal to a tag, coupled to an item of an item set that is being handled by a first individual, to determine if the item was carried to a checkout lane of a retail store;
determine whether a sale conversion for the item occurred;
if a sale conversion for the item occurred, perform the following operations:
analyzing historical sale transaction information to determine a total number of sales of items in the item set over a first given period of time;
comparing the total number of sales to a first threshold value; and
causing content displayed on the tag's electronic visual display to be dynamically changed so as to include a sale price for the item, when the total number of sales is less than or equal to the first threshold value.

13. The system according to claim 12, wherein the processor is at least partially implemented in at least one of the tag and a computing device remotely located from the tag.

14. The system according to claim 12, wherein the programming instructions further comprise instructions to cause an auditory alert to be output from the tag for informing individuals that the item has been placed on sale.

15. The system according to claim 12, wherein the programming instructions further comprise instructions to analyze the sensor data to determine if the item was handled at a first location in a facility and left at the first location.

16. The system according to claim 15, wherein the programming instructions further comprise instructions to:
determine a total number of times the item was handled and placed back at the first location over a second given period of time;
compare the total number of times the item was handled and placed back at the first location over a second given period of time to a second threshold value; and
perform at least one of the following operations when the total number of times the item was handled and placed back at the first location over a second given period of time exceeds the second threshold value:
notifying a second individual that the second threshold value has been exceeded so that the second individual can make a determination as to whether the display location of the item should be changed; and
determining a proposed new display location for the item in the facility based on pre-defined criteria, and notifying the second individual of the proposed new display location.

17. The system according to claim 16, wherein the pre-defined criteria comprises at least one of (a) item type categories assigned to different sections of the facility, (b) the item's type categorization, (c) the item's priority level relative to that of other items, and (d) historical data indicating which physical locations in a section of the facility have higher sale rates.

18. The system according to claim 12, wherein the programming instructions further comprise instructions to analyze the sensor data to determine if the item was picked up from the first location and dropped off at a second different location.

19. The system according to claim 18, wherein the programming instructions further comprise instructions to notify a second individual that that the item has been misplaced when a determination is made that the item was picked up from the first location and dropped off at a second different location.

20. The system according to claim 19, wherein the programming instructions further comprise instructions to:
determine if the item is a cold storage item;
determine if the second location is a cold storage location;
determine an amount of time the item has been removed from cold storage when a determination is made that the item is a cold storage item and the second location is not a cold storage location;
compare the amount of time to a third threshold value; and
issue a warning message to the second individual that (a) the item has passed an expiry period when the amount of time is greater than the third threshold value or (b) there is a certain amount of time until the item reaches the expiry period when the amount of time is less than the third threshold value.

21. The system according to claim 20, wherein the programming instructions further comprise instructions to cause an alert to be output from the tag alerting onlookers that the item passed the expiry period or is about to pass the expiry period.

22. The system according to claim 12, wherein the programming instructions further comprise instructions to:
analyze the sensor data to determine if the item left the facility without a sale conversion; and
notify a second individual of a possible theft of the item if a determination is made that the item left the facility without a sale conversion.
